(19) United States
(12) Patent Application Publication
(10) Pub. No.: US 2022/0230833 A1
(43) Pub. Date: Jul. 21, 2022

(54) Target Features to Increase X-Ray Flux

(71) Applicant: Moxtek, Inc., Orem, UT (US)

(72) Inventors: Kasey Otho Greenland, South Jordan, UT (US); Eric Miller, Provo, UT (US); Scott Howard Hardy, Riverton, UT (US); Todd S. Parker, Kaysville, UT (US)

(21) Appl. No.: 17/556,212

(22) Filed: Dec. 20, 2021

Related U.S. Application Data
(60) Provisional application No. 63/139,403, filed on Jan. 20, 2021.
(60) Provisional application No. 63/231,917, filed on Aug. 11, 2021.

(51) Int. Cl. H01J 35/18; H01J 35/32

(52) U.S. Cl. CPC H01J 35/186; H01J 35/32

(57) ABSTRACT

A target for an x-ray tube can emit x-rays in response to impinging electrons. Some electrons rebound without interacting atomically to form x-rays. Problems of these non-interacting electrons include reduced x-ray flux, charging electrically-insulative components of the x-ray tube, and misdirecting the electron beam. The target can include an array of holes, an array of posts, or both. The holes/posts can increase electron interaction with material of the target. Consequently, a higher percentage of impinging electrons can form x-rays. The holes/posts can also allow the target to effectively generate x-rays of different energies by providing a target with multiple thicknesses. X-rays can be generated in thicker regions of the target with the x-ray tube operated at a larger voltage. X-rays can be generated in thinner regions of the target with the x-ray tube operated at a smaller voltage.

### CLAIM OF PRIORITY

This application claims priority to US Provisional Patent Application Numbers U.S. 63/139,403, filed on Jan. 20, 2021, and U.S. 63/231,917, filed on Aug. 11, 2021, which are incorporated herein by reference.

### FIELD OF THE INVENTION

The present application is related generally to x-ray sources.

### BACKGROUND

An x-ray tube can make x-rays by sending electrons, in an electron-beam, across a voltage differential, to a target. X-rays can form as the electrons hit the target.

### BRIEF DESCRIPTION OF THE DRAWINGS (DRAWINGS MIGHT NOT BE DRAWN TO SCALE)

FIG. 1a is a cross-sectional side-view of a transmission-target x-ray tube 10a including a cathode 11 configured to emit electrons in an electron beam to a target 14. X-rays 17 can emit out of the x-ray tube 10 through the target 14 and an adjacent x-ray window 13.

FIG. 1b is a cross-sectional side-view of a transmission-target x-ray tube 10b, similar to transmission-target x-ray tube 10a. Transmission-target x-ray tube 10b has a differently shaped anode 12 and electrically-insulative structure 15.

FIG. 2 is a cross-sectional side-view of a reflective-target, side-window x-ray tube 20. A cathode 11 can emit electrons in an electron beam to a target 14. X-rays 17 can transmit through an interior of the x-ray tube 20, and out of the x-ray tube 20 through an x-ray window 13.

FIG. 3 is an expanded cross-sectional side-view of a target 14 with an array of holes 33, preferably for transmission-target x-ray tubes 10a and 10b.

FIG. 4 is an expanded cross-sectional side-view of a target 14 with an array of posts 43, preferably for transmission-target x-ray tubes 10a and 10b.

FIG. 5 is an expanded cross-sectional side-view of a target 14 with an array of holes 33, preferably for a reflective-target, side-window x-ray tube 20.

FIG. 6 is an expanded cross-sectional side-view of a target 14 with an array of posts 43, preferably for a reflective-target, side-window x-ray tube 20.

FIG. 7 is an expanded cross-sectional side-view of a hole 33 in a target 14 with bumps 73 on sidewalls 33ₛ of the hole 33.

FIG. 8 is an expanded cross-sectional side-view of a hole 33 in a target 14. A diameter Dₕ, of the hole 33 decreases moving deeper into the hole 33.

FIG. 9 is an expanded cross-sectional side-view of a hole 33 in a target 14. A diameter Dₕ, of the hole 33 increases moving deeper into the hole 33.

FIG. 10 is an expanded cross-sectional side-view of a target 14 with a top-layer 14t closest to the cathode 11, a bottom-layer 14b farther from the cathode 11, and a hole 33 extending through the top-layer 14t.

FIG. 11a is an expanded cross-sectional side-view of a target 14, similar to the target of FIG. 10, except that a diameter Dₕ of the hole 33 in FIG. 11a increases linearly moving deeper into the hole 33, closer to the bottom-layer 14b.

FIG. 11b is an expanded cross-sectional side-view of a target 14, similar to the target of FIG. 10, except that a diameter Dₕ, of the hole 33 in FIG. 11b increases in a step, moving deeper into the hole 33, closer to the bottom-layer 14b.

FIG. 12 is an expanded cross-sectional side-view of a target 14, similar to the targets of FIGS. 10 and 11a-b, except that the target 14 of FIG. 12 has gap G between the top-layer 14t and the bottom-layer 14b.

FIG. 13 is a top-view of a target 14 with a grid array of holes 33 with aligned columns 131 and rows 132.

FIG. 14 is a top-view of a target 14 with an array of holes 33. Each hole 33 has a hexagonal shape. The array of holes 33 combine to form repeating hexagonal shapes 141 and 142.

FIG. 15 is a top-view of a target 14 with an array of holes 33. Each hole 33 has a circular shape. The array of holes 33 combine to form repeating hexagonal shapes 141.

FIG. 16 is a top-view of a target 14 with an array of posts 43.

FIG. 17 is a perspective-view of a target 14 with alternating wires 44 and channels in an elongated, parallel array. The wires 44 are posts 43 and the channels are holes 33.

FIG. 18 is a top-view of a target 14 with alternating wires 44 and channels in a zig-zag pattern. The wires 44 are posts 43 and the channels are holes 33.

FIG. 19 is a cross-sectional side-view of a target 14 with a bottom-layer 14b that is a continuous film, and an array of wires 44 on the bottom-layer 14b.

FIG. 20 is a cross-sectional side-view of a target 14 with a bottom-layer 14b that is a continuous film, and posts 43_{A}, 43_{B}, and 43_{C} on the bottom-layer 14b. The target 14 has multiple thicknesses T_{B}, T_{PA}, T_{PB}, and T_{PC}.

FIG. 21 is a perspective-view of a step 210 in a method of making a target 14 for an x-ray tube, including patterning and etching a first array of channels 211 in a target material, or patterning and sputtering an array of wires 44 of target material, in a first direction D1.

FIG. 22 is a top-view of a step 220 in a method of making a target 14 for an x-ray tube, including patterning and etching a second array of channels 221 in the target material, or patterning and sputtering an array of wires 224 of target material, in a second direction D2. The second direction D2 is different from the first direction D1. This step 220 forms an array of posts 43 extending from the bottom-layer 14b.

FIG. 23 is a side-view of a method 230 of making a target 14 for an x-ray tube, including using a laser 231 or 232 to form holes 33 in the target 14, posts 43 on the target, or both.

Definitions. The following definitions, including plurals of the same, apply throughout this patent application.

As used herein, the face 14e of the target 14 is a face or side of the target 14 that faces the electron beam, and into which the holes 33 penetrate or from which the posts 43 protrude.

As used herein, the terms “on”, “located on”, “located at”, and “located over” mean located directly on or located over with some other solid material between. The terms “located directly on”, “adjoin”, “adjoins”, and “adjoining” mean direct and immediate contact.

As used herein, the term “parallel” means exactly parallel, or within 10° of exactly parallel. The term “parallel” can mean within 0.1°, within 1°, or within 5° of exactly parallel if explicitly so stated in the claims.

As used herein, the term “unparallel” means the lines or surfaces intersect at an angle greater than 10°.

As used herein, the term “perpendicular” means exactly perpendicular, or within 10° of exactly perpendicular. The term “perpendicular” can mean within 0.1°, within 1°, or within 5° of exactly perpendicular if explicitly so stated in the claims.

As used herein, terms like “same”, “equal”, and “identical” mean (a) exactly the same, equal, or identical; (b) the same, equal, or identical within normal manufacturing tolerances; or (c) nearly the same, equal, or identical such that any deviation from exactly the same, equal, or identical would have negligible effect for ordinary use of the device.

Shapes described herein can have (a) the exactly described shape (e.g. circular, hexagonal, etc.); (b) the described shape within normal manufacturing tolerances; or (c) nearly the exactly described shape, such that any deviation from the exactly described shape would have negligible effect for ordinary use of the device.

As used herein, the term “x-ray tube” is not limited to tubular/cylindrical shaped devices. The term “tube” is used because this is the standard term used for x-ray emitting devices.

As used herein, the term “nm” means nanometer(s), the term “μm” means micrometer(s), and the term “mm” means millimeter(s).

### DETAILED DESCRIPTION

An x-ray tube can make x-rays by sending electrons, in an electron-beam, across a voltage differential, to a target. X-rays can form as the electrons hit the target. Some electrons rebound without interacting atomically to form x-rays. Thus, x-ray flux is reduced.

The rebounded electrons can charge electrically-insulative components of the x-ray tube, which may result in deflection of the electron beam, and increased chance of electrical breakdown of the x-ray tube.

The invention reduces electron rebound to the electrically-insulative components of the x-ray tube. The invention can increase x-ray flux, decrease electron beam deflection, and decrease x-ray tube electrical breakdown failure.

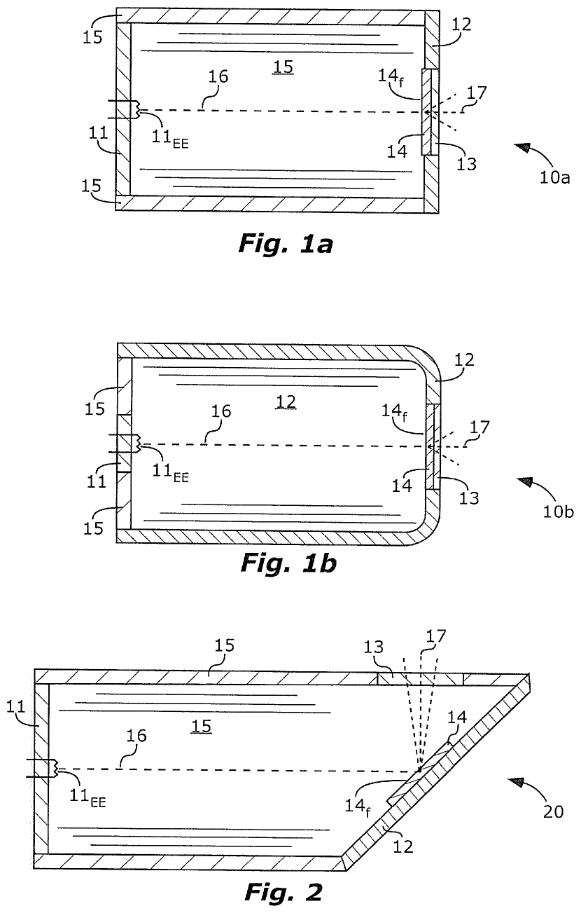

As illustrated in FIGS. 1a-2, x-ray tubes 10a, 10b, and 20 include a cathode 11 and an anode 12 electrically insulated from one another. For example, an electrically-insulative structure 15 can separate and insulate the cathode 11 from the anode 12. Example materials for the electrically-insulative structure 15 include glass and ceramic. The electrically-insulative structure 15 can be a cylinder, as illustrated in FIGS. 1a and 2.

The cathode 11 can be configured to emit electrons (e.g. from an electron emitter 11_{EE}, such as a filament) in an electron beam to a target 14 at the anode 12. The target 14 can be configured to emit x-rays 17 out of the x-ray tube 10a, 10b, and 20 in response to impinging electrons from the cathode 11. The target 14 can include high melting point material(s) for generation of the x-rays, such as rhodium, tungsten, or gold.

Transmission-target x-ray tubes 10a and 10b are illustrated in FIGS. 1a-1b. The target 14 can be attached to the x-ray window 13. The target 14 can adjoin the x-ray window 13. X-rays 17 generated in the target 14 can transmit through the target 14 and the x-ray window 13, and out of the x-ray tube 10a or 10b.

A reflective-target, side-window x-ray tube 20 is illustrated in FIG. 2. The x-ray window 13 can be spaced apart from the target 14. A region of an evacuated interior of the x-ray tube can be between the x-ray window 13 and the target 14. X-rays 17 generated in the target 14 can transmit through an internal vacuum of the x-ray tube 20 to the x-ray window 13, and out of the x-ray tube 20.

The invention is applicable to both transmission-target x-ray tubes 10a and 10b and to reflective-target, side-window x-ray tubes 20. The invention can increase electron interactions with the target 14.

Holes 33 in the target 14, posts 43 on the target 14, or both can increase electron interaction with material of the target 14. Rebounding electrons can hit a sidewall or a bottom of the hole 33, or hit a post 43, instead of hitting and charging the electrically-insulative structure 15. There is a chance of forming an x-ray 17 each time a rebounded electron hits the target 14. Thus, by adding holes 33/posts 43 to the target 14, x-ray flux can increase for a given electron beam. Alternatively, the power of the electron beam can be reduced while achieving the same x-ray flux. Reducing the electron beam power can increase x-ray tube life and reduce power requirements.

Holes 33, posts 43, or both can also allow the target 14 to effectively generate x-rays 17 of different energies by providing a target 14 with multiple thicknesses. When the x-ray tube 10a, 10b, or 20 is operated at a larger voltage, x-rays 17 can be generated in thicker regions Th₁ of the target 14. When the x-ray tube 10a, 10b, or 20 is operated at a smaller voltage, x-rays 17 can be generated in thinner regions Th₂ of the target 14.

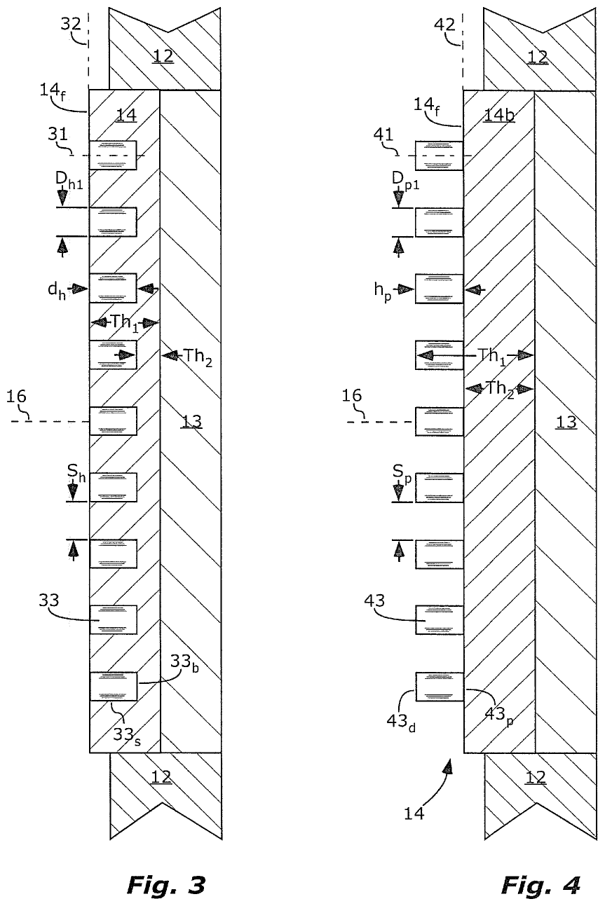

As illustrated in FIGS. 3 and 5, the target 14 can include an array of holes 33. The target 14 can encircle each hole 33, at a face 14r of the target 14 and along an entire depth of the hole 33. A bottom 33_{b} and a sidewall 33ₛ of the holes 33 can have an identical material composition. The sidewall 33ₛ of the holes 33 can have an identical material composition along an entire depth of the hole 33. All holes 33 can be identical with respect to each other. Sidewalls 33ₛ of all the holes 33 can have an identical material with respect to each other. The bottom 33_{b} of all the holes 33 can have an identical material with respect to each other.

A longitudinal-axis 31 for each of the holes 33 can be parallel to a longitudinal axis 16 of the x-ray tube, parallel to the electron beam, or both. The longitudinal axis 16 of the x-ray tube can extend between the cathode 11 and the target 14. This parallel arrangement can increase electron capture, which can increase x-ray flux.

The target 14 in FIG. 3 is preferred for a transmission-target x-ray tubes 10a and 10b. The longitudinal-axis 31 for holes 33 of target 14 in FIG. 3 can be perpendicular to a plane 32 of a face 14_{f} of the target 14.

The target 14 in FIG. 5 is preferred for a reflective-target, side-window x-ray tube 20. The longitudinal-axis 31 for holes 33 of target 14 in FIG. 5 can be non-perpendicular to a plane 32 of a face 14_{f} of the target 14. For example, 100°≤Aₕ, 110°≤Aₕ, or 120°≤Aₕ; and Aₕ≤120°, Aₕ≤130°, or Aₕ≤140°; where Aₕ is an angle between the longitudinal-axis 31 of the holes 33 and the plane 32.

In the target 14 of FIG. 3 or of FIG. 5, a depth dₕ of the holes 33 can be the same with respect to each other. This can simplify design and manufacturing. Alternatively, hole depth dₕ and longitudinal axis 31 of the holes 33 can be adjusted according to the angle of incidence for electrons at the specific location of the target 14. Hole depth dₕ is measured at a center of the hole 33.

Minimum hole diameter Dₕ₁, as measured at a face 14_{f} of the target 14, can be selected for increased capture of electrons, and increased x-ray flux. For example, 10 nm≤Dₕ₁, 100 nm≤Dₕ₁, or 1 μm≤Dₕ₁; and Dₕ₁≤1 μm, Dₕ₁≤10 μm, Dₕ₁≤20 μm, Dₕ₁≤50 μm, or Dₕ₁≤100 μm.

Proper selection of aspect ratio ARₕ of the holes 33 can increase capture of electrons. The equation for aspect ratio is ARₕ=dₕ/Dₕ₁ (dₕ and Dₕ₁ are defined above).

A relatively higher aspect ratio ARₕ is preferred for transmission-target x-ray tubes 10a and 10b, because generated x-rays 17 must pass through the target 14 anyway. Thus, there is no concern of generating these x-rays 17 deep in the target 14. Example aspect ratios ARₕ for transmission-target x-ray tubes 10a and 10b include 0.5≤ARₕ, 1≤ARₕ, or 5≤ARₕ; and ARₕ≤5, ARₕ≤10, or ARₕ≤20.

In contrast, a relatively lower aspect ratio ARₕ is preferred for a reflective-target, side-window x-ray tube 20 because x-rays 17 generated deep in the target 14 must pass through the target 14 back into the evacuated enclosure of the x-ray tube 20. X-rays 17 thus generated deep in the target 14 can be unduly attenuated. Example aspect ratios ARₕ for a reflective-target, side-window x-ray tube 20 include 0.1≤ARₕ, 0.5≤ARₕ, or 1≤ARₕ; and ARₕ≤1, ARₕ≤3, or ARₕ, ≤6.

Optimal selection of minimum distance Sₕ between adjacent holes 33 can increase capture of electrons. If the minimum distance Sₕ is too small, then electrons can pass through the sidewall of one hole 33 and into another hole 33 without generation of an x-ray 17. Alternatively, if the minimum distance Sₕ is too large, then there are fewer holes 33 for capture of electrons. Example ranges for the minimum distance Sₕ between adjacent holes 33 include 50 nm≤Sₕ, 300 nm≤Sₕ, or 1 μm≤Sₕ; and Sₕ≤1 μm, Sₕ≤10 μm, Sₕ≤20 μm, or Sₕ, ≤50 μm. Sₕ is measured at a face 14f of the target 14.

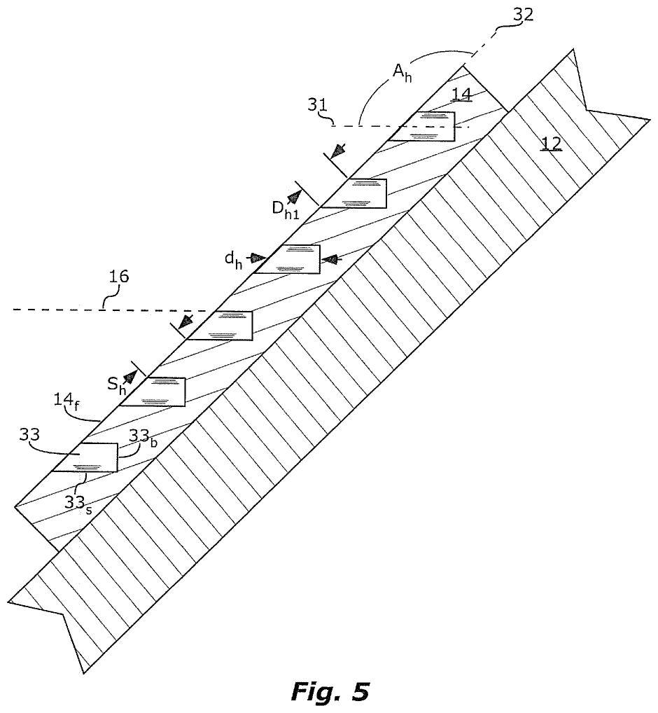

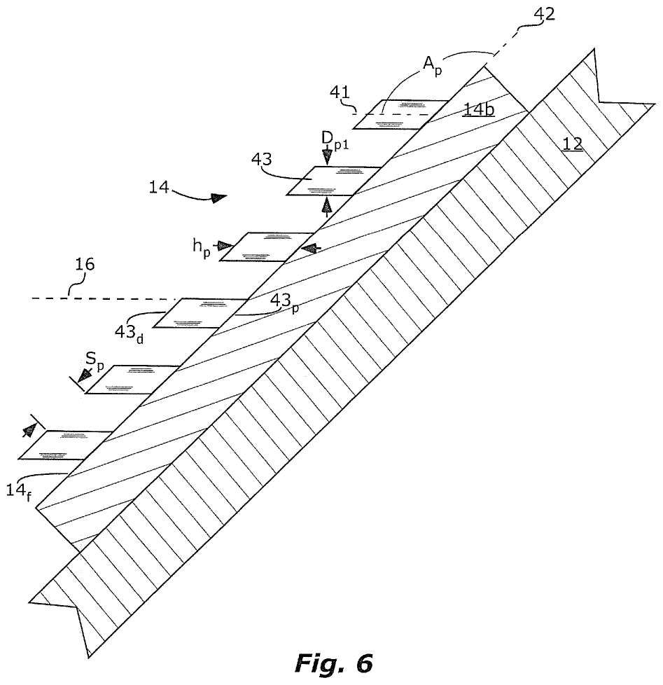

As illustrated in FIGS. 4 and 6, the target 14 can include an array of posts 43 on a bottom-layer 14b. The bottom-layer 14b can be a continuous film. The posts 43 and the bottom-layer 14b can have an identical material composition. Alternatively, the posts 43 and the bottom-layer 14b can be made of different materials. Adjacent posts 43 can be separated from each other (not touching) from a proximal-end 43ₚ at the bottom-layer 14b to a distal-end 43_{d} farthest from the bottom-layer 14b.

Each post 43 can have an identical material composition along an entire height hₚ of the post 43. All posts 43 can have an identical material composition with respect to each other. All posts 43 can be identical with respect to each other.

In the targets 14 of FIG. 4 or FIG. 6, a longitudinal-axis 41 for each of the posts 43 can be parallel to the electron beam, parallel to a longitudinal axis 16 of the x-ray tube, or both. This parallel arrangement can increase electron capture and electron rebound, which can increase x-ray flux.

The target 14 in FIG. 4 is preferred for transmission-target x-ray tubes 10a and 10b. The longitudinal-axis 41 for the posts 43 can be perpendicular to a plane 42 of a face 14_{f} of the target 14.

The target 14 in FIG. 6 is preferred for a reflective-target, side-window x-ray tube 20. The longitudinal-axis 41 can be non-perpendicular to a plane 42 of a face 14₁ of the target 14. For example, 100°≤Aₚ, 110°≤Aₚ, or 120°≤Aₚ; and Aₚ≤120°, Aₚ≤130°, or Aₚ≤135°; where Aₚ is an angle between the longitudinal-axis 31 for the posts 43 and the plane 32.

In the targets 14 of FIG. 4 or FIG. 6, a height hₚ of the posts 43 can be the same with respect to each other. This can simplify design and manufacturing. Alternatively, post height hₚ can be adjusted according to the angle of incidence for electrons at the specific location of the target 14. Post height hₚ is measured at a center of the post 43.

Minimum post diameter Dₚ₁, measured perpendicular to the longitudinal-axis 41, can be selected for increased capture of electrons, and increased x-ray flux. If the minimum post diameter Dₚ₁ varies along the height hₚ of the post 43, then the minimum post diameter Dₚ₁ is defined as the smallest diameter at a midpoint on the post 43 between the proximal-end 43ₚ and the distal-end 43_{d}. If the minimum post diameter Dₚ₁ is too small, then electrons can pass through the post 43 without generation of an x-ray 17. Alternatively, if the minimum post diameter Dₚ₁ is too large, then there are fewer posts 43 for capture of electrons. Example minimum post diameters Dₚ₁ include 10 nm≤Dₚ₁, 100 nm≤Dₚ₁, or 1 μm≤Dₚ₁; and Dₚ₁≤1 μm, Dₚ₁≤10 μm, or Dₚ₁≤100 μm.

Proper selection of aspect ratio ARₚ of the posts 43 can increase capture of electrons. The equation for aspect ratio is ARₚ=hₚ/Dₚ₁ (hₚ and Dₚ₁ are defined above).

A higher aspect ratio ARₚ is preferred for transmission-target x-ray tubes 10a and 10b, because generated x-rays 17 must pass through the target 14 anyway. Thus, there is no concern of generating these x-rays closer to the proximal-end 43ₚ of the post 43. Example aspect ratios ARₚ for a transmission-target x-ray tube 10 include 0.5≤ARₚ, 1≤ARₚ, or 5≤ARₚ; and ARₚ≤5, ARₚ≤10, or ARₚ≤20.

In contrast, a relatively lower aspect ratio ARₚ is preferred for a reflective-target, side-window x-ray tube 20 because x-rays 17 generated deep in the target 14 must pass through the target 14 back into the evacuated enclosure of the x-ray tube 20. X-rays 17 thus generated deep in the target 14 can be unduly attenuated. Example aspect ratios ARₚ for a reflective-target, side-window x-ray tube 20 include 0.1≤ARₚ, 0.5≤ARₚ, or 1≤ARₚ; and ARₚ≤1, ARₚ≤3, or ARₚ≤6.

Proper selection of minimum distance Sₚ between adjacent posts 43 can increase capture of electrons. The minimum distance Sₚ between any two adjacent posts 43 is the closest straight-line path between these posts 43, measured at the distal-end 43_{d}.

If the minimum distance Sₚ is too small, then too many electrons won't enter gaps between posts. Alternatively, if the minimum distance Sₚ is too large, then too many electrons will hit the bottom-layer 14b and reflect away from the target 14. Example ranges for the minimum distance Sₚ between adjacent posts 43 include 50 nm≤Sₚ, 300 nm≤Sₚ, or 1 μm≤Sₚ; and Sₚ≤1 μm, Sₚ≤10 μm, or Sₚ≤50 μm. Sₚ is measured at a face 14_{f} of the target 14.

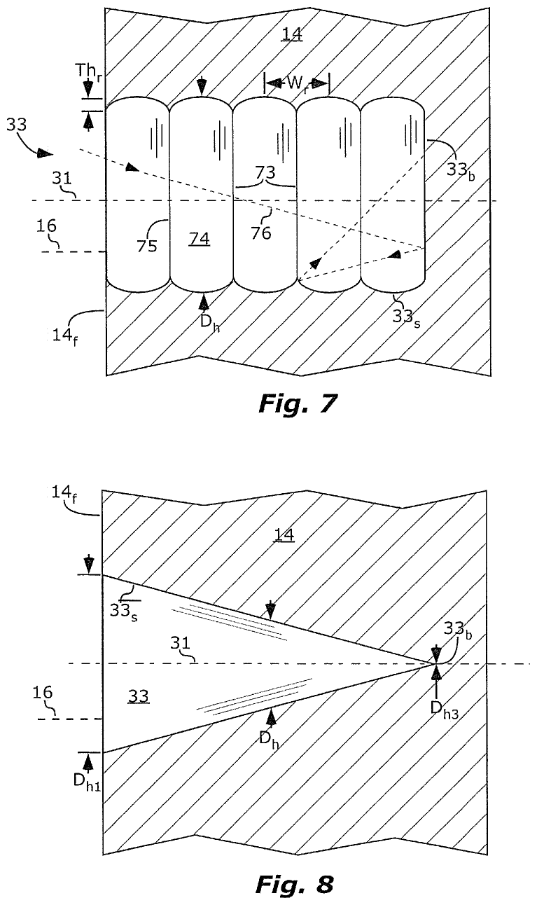

As illustrated in FIGS. 7-9 and 11a, an average direction of sidewalls 33ₛ of the holes 33 can be unparallel with respect to the electron beam, unparallel with respect to the longitudinal axis 16 of the x-ray tube, or both. The direction of the electron beam is based on an average direction of electrons travelling from the electron emitter 11_{EE} to the target 14. The hole 33 shapes of FIGS. 7-9 and 11a-b are applicable to both transmission-target x-ray tubes 10a and 10b and to reflective-target, side-window x-ray tubes 20. The hole 33 shapes of FIGS. 7-9 and 11a-b can be combined with the other details of the target 14 in FIGS. 3-6 and 12-16.

As illustrated in FIG. 7, bumps 73 on the sidewall 33, can cause a direction of the sidewalls 33ₛ of the holes 33 to be unparallel with respect to the longitudinal axis 16 of the x-ray tube. This direction can change, and a majority of this direction can be unparallel with respect to the electron beam, unparallel with respect to the longitudinal axis 16 of the x-ray tube, or both. The bumps 73 can increase x-ray production by reflecting electrons that hit a base of the hole 33, back to the target 14. It is preferable for the bumps 73 to be angled to reflect electrons to the bottom 33_{b} or other sidewalls 33ₛ, in order to increase electron interaction with the target 14. See for example the path 76 followed by an example electron.

The bumps 73 can cover a large percent of a surface of the sidewalls 33ₛ, in order to increase electron interaction with the target 14. For example, ≥25%, ≥50%, ≥80%, ≥90%, or ≥99% of a surface of the sidewalls 33ₛ can be covered by the bumps 73.

The bumps 73 can be ribs 75 with channels 74 between the ribs 75. The ribs 75 can encircle the longitudinal-axis 31 along sidewalls 33ₛ of each hole 33 and can extend into each hole 33. The ribs 75 can be pointed ridges. Each concave channel 74 can encircle the longitudinal-axis 31 along sidewalls 33ₛ of each hole 33. The ribs 75 can be relatively easy to make and can increase electron interaction with the target 14 by encircling each hole 33.

Example numbers of ribs 75 in each hole 33 include≥3 ribs, ≥5 ribs, ≥10 ribs, or ≥25 ribs. Example widths Wᵣ of the ribs (parallel to the longitudinal-axis 31) include 10 nm≤Wᵣ, 50 nm≤Wᵣ, or 200 nm≤Wᵣ; and Wᵣ≤300 nm, Wᵣ≤1500 nm, or Wᵣ≤6000 nm. Example thicknesses Thᵣ of the ribs (perpendicular to the longitudinal-axis 31, into the hole) include 5 nm≤Thᵣ, 15 nm≤Thᵣ, or 45 nm≤Thᵣ; and Thᵣ≤150 nm, Thᵣ≤500 nm, or Thᵣ≤1500 nm.

The bumps 73 and ribs 75 are applicable to both transmission-target x-ray tubes 10a and 10b and to reflective-target, side-window x-ray tubes 20, and can be combined with other target 14 features described herein.

The bumps 73 can be formed by alternating isotropic and anisotropic etching (e.g. ≥2, ≥4, or ≥8 of each type of etch). The isotropic etching can form wider regions of the holes 33 (e.g. between ribs 75) and the anisotropic etching can form narrower regions of the holes 33 (e.g. where the ribs 75 protruded into the hole 33). Deep reactive-ion etching milling can also form the holes 33 with the bumps 73.

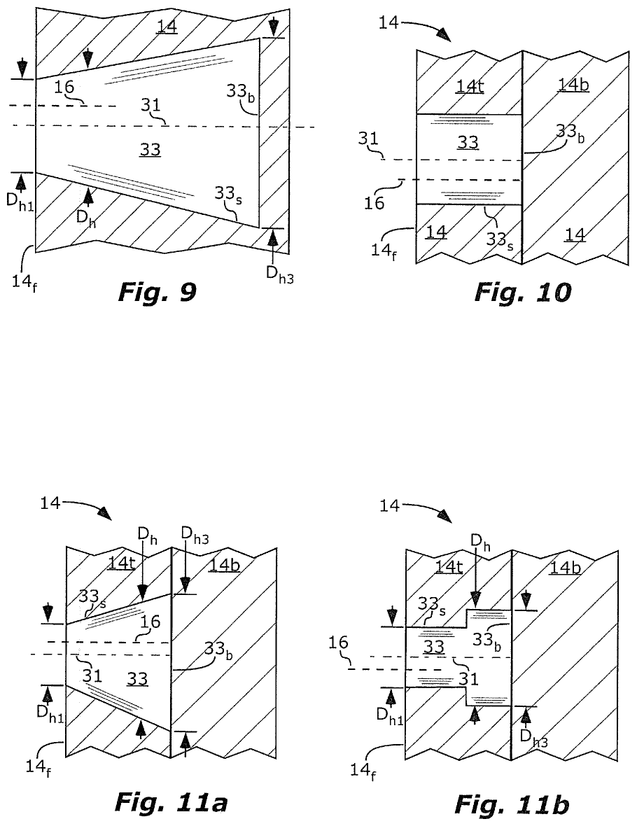

As illustrated in FIGS. 8-9, a narrowing or widening of the holes 33 can cause an average direction of the sidewalls 33ₛ of the holes 33, or a majority direction of the sidewalls 33ₛ of the holes 33, to be unparallel with respect to the electron beam, unparallel with respect to the longitudinal axis 16 of the x-ray tube, or both. The narrowing or widening of the holes 33 in FIGS. 8-9 are applicable to both transmission-target x-ray tubes 10a and 10b and to reflective-target, side-window x-ray tubes 20, and can be combined with other target 14 features described herein.

In FIG. 8, the holes 33 decrease in diameter Dₕ moving deeper into the holes 33. Thus, a minimum diameter Dₕ₁ of the hole 33 measured at a face 14_{f} of the target 14 can be greater than a minimum diameter Dₕ₃ of the hole 33 measured at a bottom 33_{b} of the hole 33. Example relationships between these diameters include Dₕ₁/Dₕ₃≥1.25, Dₕ₁/Dₕ₃≥1.5, Dₕ₁/Dₕ₃≥2, and Dₕ₁/Dₕ₃≥10.

A linear decrease in diameter Dₕ is shown in FIG. 8, but this change in diameter Dₕ can be a step (opposite of FIG. 11b). This decrease in diameter Dₕ, moving deeper into the holes 33, can be formed by a laser or by etching. This shape has the disadvantage that electrons entering the hole 33 can more easily reflect back towards the cathode or the electrically-insulative structure 15. This shape has the advantage that the holes 33 can be placed closer together (decreased Sₕ).

In FIG. 9, the holes 33 increase in diameter Dₕ moving deeper into the holes 33. A linear increase in diameter Dₕ is shown in FIG. 9, but this change in diameter can be a step, as illustrated in FIG. 11b. Thus, a minimum diameter Dₕ₁ of the hole 33 measured at a face 14_{f} of the target 14 can be smaller than a minimum diameter Dₕ₃ of the hole 33 measured at a bottom 33ₕ of the hole 33. Example relationships between these diameters include Dₕ₃/Dₕ₁≥1.1, Dₕ₃/Dₕ₁≥1.25, Dₕ₃/Dₕ₁≥1.5, and Dₕ₃/Dₕ₁≥2.

This shape can be formed by isotropic etching. This shape has the disadvantage that the holes 33 may need to be placed farther apart (increased Sₕ). This shape has the advantage that electrons entering the hole 33 can more easily reflect back towards a bottom 33_{b} of the hole 33 or sidewalls of the hole 33.

Each hole 33 can have a conical shape (FIG. 8) or a conical frustum shape (FIGS. 9 and 11).

As illustrated in FIGS. 10-12, the target 14 can include a top-layer 14t closest to the cathode 11 and a bottom-layer 14b farther from the cathode 11. The top-layer 14t and the bottom-layer 14b are applicable to both transmission-target x-ray tubes 10a and 10b and to reflective-target, side-window x-ray tubes 20, and to other target features described herein.

The array of holes 33 can be in the top-layer 14t. Each hole 33 can extend through the top-layer 14t to expose the bottom-layer 14b. A side of the bottom-layer 14b facing the top-layer 14t can be free of holes 33. Boring holes 33 completely through the top-layer 14t, then attaching the top-layer 14t to the bottom-layer 14b, can improve consistency in manufacturing hole depth dₕ.

The top-layer 14t can have a different material composition from the bottom-layer 14b. The top-layer 14t can have≥75, ≥85, or ≥95 weight percent of one chemical element and the bottom-layer 14b can have ≥75, ≥85, or ≥95 weight percent of another chemical element. Example chemical elements for the top-layer 14t and the bottom-layer 14b include transition metals, lanthanoids, some specific refractory metals (such as Zr, Mo, W, Hf, Ta, Re, Os, Ir), precious metals (such as Au, Pt, Pd, Rh, and Ag), and other metals (such as Ti, Cr, Fe, Co, Ni, and Cu). An atomic number of a majority element (by atomic weight) in the top-layer 14t can be greater than an atomic number of a majority element (by atomic weight) in the bottom-layer 14b.

As illustrated in FIG. 11a, the holes 33 through the top-layer 14t can have conical frustum shape. These can be formed by laser cutting from the wider diameter side, then placing this wider diameter side adjacent to the bottom-layer 14b.

As illustrated in FIG. 11b, the holes 33 through the top-layer 14t can have widening diameter Dₕ, moving deeper into the hole. The widening diameter Dₕ can be abrupt, like a step. These can be formed by laser cutting (a) across the wider diameter with limited time to avoid cutting all the way through, and (b) cutting the center all the way through. The wider diameter side can be placed next to the bottom-layer 14b.

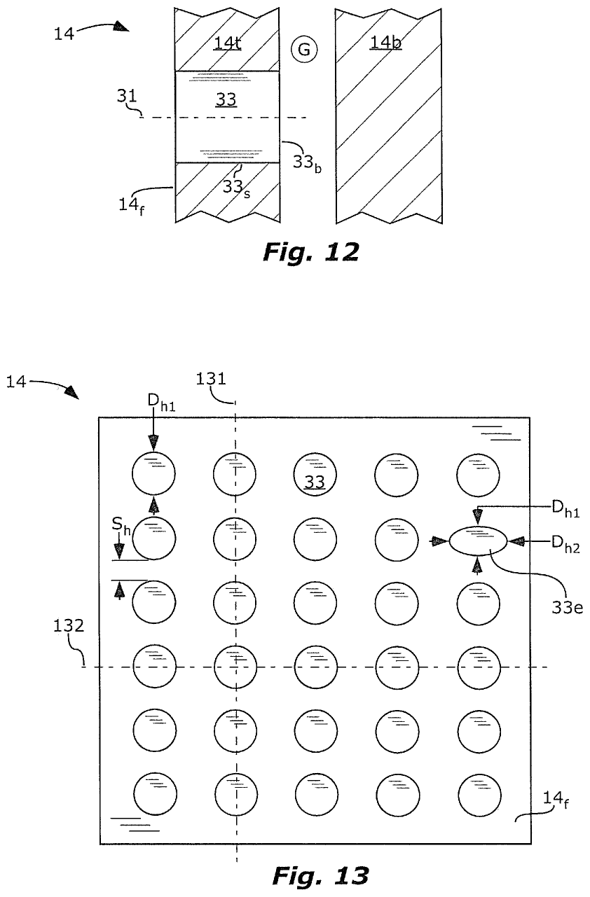

As illustrated in FIG. 12, the top-layer 14t and the bottom-layer 14b can be spaced apart, with a gap G between them. The gap G can be filled with vacuum, gas, or both. Benefits of the gap G include (a) avoiding damage to the target 14 caused by differences in the coefficient of thermal expansion between the top-layer 14t and the bottom-layer 14b, (b) avoiding trapped gas between the top-layer 14t and the bottom-layer 14b, (c) increased rate for forming a vacuum in the x-ray tube, and (d) increased capture of electrons that pass all the way through the holes 33.

FIGS. 13-15 are top-views of the array of holes 33 in the target 14. The hole 33 arrangements and shapes of FIGS. 13-15 are applicable to both transmission-target x-ray tubes 10a and 10b and to reflective-target, side-window x-ray tubes 20. Any of the hole 33 cross-sectional shapes of FIGS. 7-9 may be combined with the hole 33 arrangements and shapes of FIGS. 13-15. Any of the layered targets of FIGS. 10-12 may be combined with the hole 33 arrangements and shapes of FIGS. 13-15.

Example numbers of holes 33 in the target 14 include ≥5, ≥25, ≥75, or ≥150. By proper selection of the number of holes 33 and minimum hole diameter Dₕ₁, a large percent of the electron beam can enter the holes 33. For example, ≥25%, ≥50%, ≥75%, or ≥90% of the electron beam can enter the holes 33.

As illustrated in FIG. 13, the rows 132 and columns 131 can be aligned in a grid array. A disadvantage of the example in FIG. 13 is variable distance between adjacent holes 33 and reduced packing of holes 33.

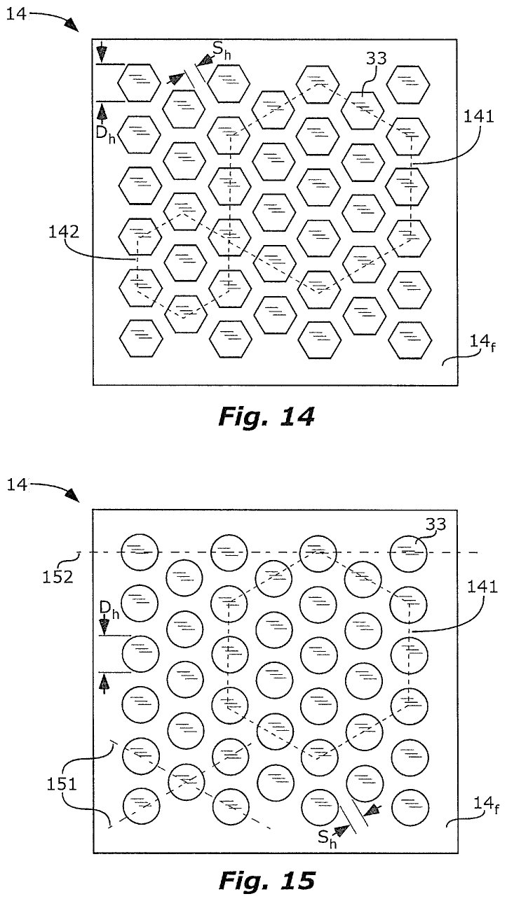

As illustrated in FIGS. 14-15, the holes 33 and the adjacent rows of the array of holes can be offset with respect to each other for more consistent and/or reduced spacing between adjacent holes 33. This can allow more holes 33 to be packed into the target 14, and thus capture more electrons. This offset can be described by (a) a line 152 across each row, through a center of holes 33 in that row, can cross holes 33 of every other column; (b) an X shape 151 can be formed by each group of five holes 33, with one of the five holes 33 at a center of the X shape 151; (c) the array of holes 33 can form repeating hexagonal shapes 141 and 142; or (d) combinations thereof. Hexagonal shape 141 includes nineteen holes. Hexagonal shape 142 includes seven holes.

As illustrated in FIG. 14, each hole 33 can have a hexagonal shape at a face 14_{f} of the target 14. The hexagonal shape can further provide more consistent wall thickness between adjacent holes 33; but hexagonal-shaped holes 33 can be more difficult to manufacture. The hexagonal shaped hole 33 can apply to other target 14 examples herein.

The holes 33 can have other shapes, including triangle, square, rectangle, circular, or elliptical at a face 14_{f} of the target 14. The target 14 of FIG. 13 has an elliptical hole 33e with a minimum diameter Dₕ₁ and a maximum diameter Dₕ₂, both measured at a face 14_{f} of the target 14. Example relationships between these diameters include 1.05≤Dₕ₂/Dₕ₁, 2≤Dₕ₂/Dₕ₁, 10≤Dₕ₂/Dₕ₁, Dₕ₂/Dₕ₁≤1.1, Dₕ₂/Dₕ₁≤2, Dₕ₂/Dₕ₁≤5, Dₕ₂/Dₕ₁≤10, Dₕ₂/Dₕ₁≤100.

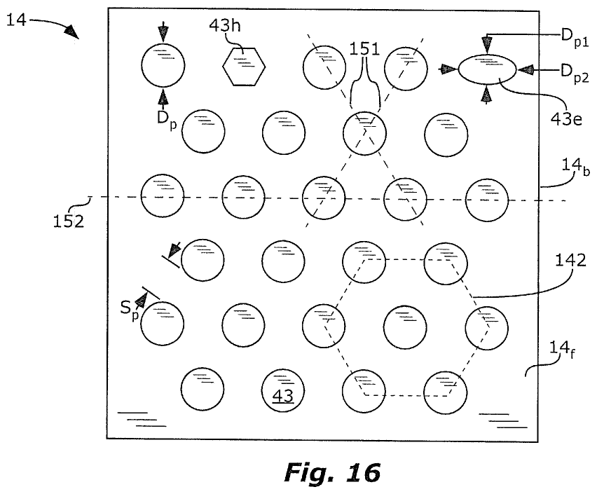

FIG. 16 is a top-view of the array of posts 43 on the target 14. Example numbers of posts 43 on the target 14 include ≥5, ≥10, ≥25, ≥75, or ≥150. All posts 43 can be identical with respect to each other. Rows and columns of posts 43 can be aligned in a grid array, similar to the holes 33 of FIG. 13. Alternatively, as illustrated in FIG. 16, the posts 43 can be offset with respect to each other for more consistent and/or minimized average distance between adjacent posts 43. This can allow more posts 43 to be packed into the target 14, and thus capture of more electrons. This offset can be described by (a) a line 152 across each row can cross posts 43 of every other column; (b) an X shape 151 can be formed by each group of five posts 43, with one of the five posts 43 at a center of the X shape 151; (c) the array of posts 43 can form repeating hexagonal shapes 142; or (d) combinations thereof.

The posts 43 can have a hexagonal shape at its proximal end 43ₚ, at its distal end 43_{d}, or both, similar to the shape of the holes 33 in FIG. 14. One post 43h with a hexagonal shape is illustrated in FIG. 16. The hexagonal shape can provide a consistent distance between adjacent posts 43 and closer packing of posts 43; but hexagonal-shaped posts 43 can be more difficult to manufacture.

The posts 43 can have other shapes, including triangle, square, rectangle, or elliptical. The target 14 of FIG. 16 has an elliptical post 43e with a minimum diameter Dₚ₁ and a maximum diameter Dₚ₂, both measured perpendicular to the longitudinal-axis 41 at a midpoint between the proximal-end 43ₚ and the distal-end 43_{d}. Example relationships between these diameters include 1.05≤Dₚ₂/Dₚ₁, 2≤Dₚ₂/Dₚ₁, 10≤Dₚ₂/Dₚ₁, Dₚ₂/Dₚ₁ 1.1, Dₚ₂/Dₚ₁≤2, Dₚ₂/Dₚ₁≤5, Dₚ₂/Dₚ₁≤10, Dₚ₂/Dₚ₁≤100.

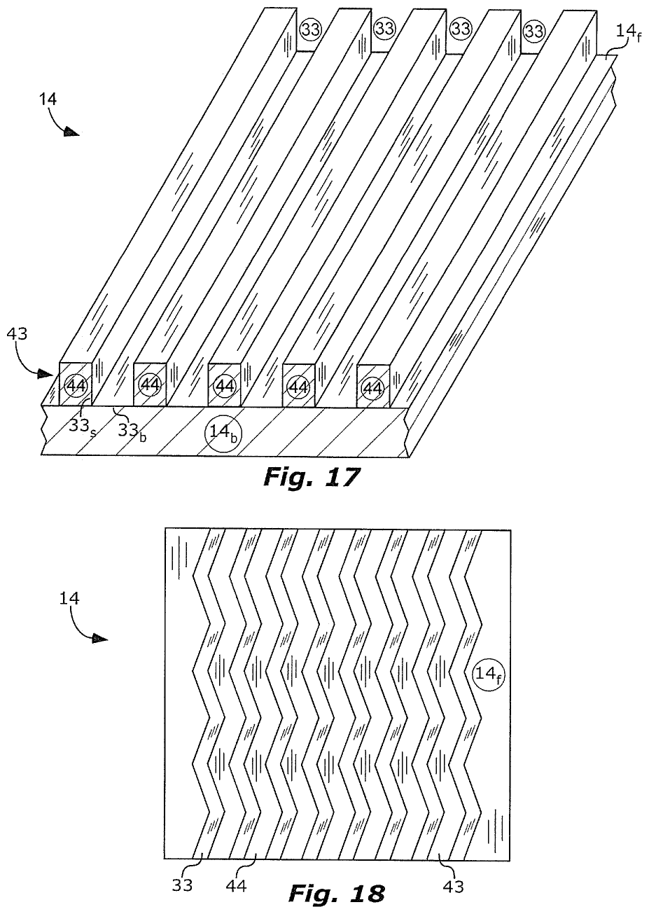

Illustrated in FIG. 17 is a perspective-view of a target 14 with an array of holes 33 and an array of posts 43 as alternating ribs and channels. FIG. 18 is a top-view of a target 14 with an array of holes 33 and an array of posts 43 as alternating ribs 44 and channels 33 in a zig-zag pattern. The zig-zag can improve capture of electrons, but can be more complicated to manufacture than the straight channels and ribs of FIG. 17.

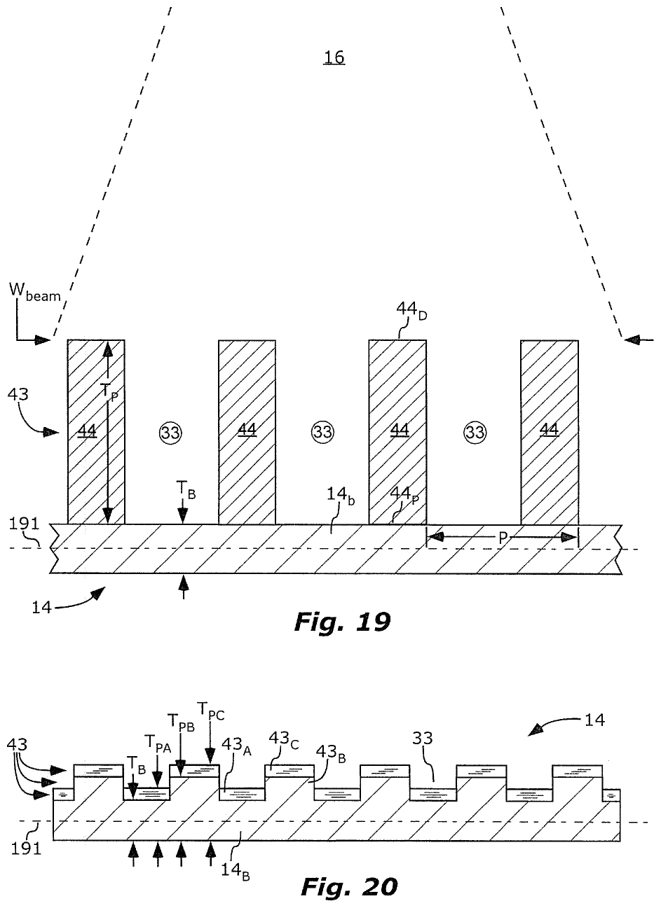

Illustrated in FIGS. 19-20 are targets 14 for x-ray tubes with posts 43 arising out of a bottom-layer 14b. The bottom-layer 14b can be a continuous film in a single plane 191. There can be holes 33 between adjacent posts 43.

In the target 14 of FIG. 19, the holes 33 can be channels and the posts 43 can be an array of wires 44. The wires 44 can be separated from each other from a proximal-end 44ₚ at the bottom-layer 14b to a distal-end 44_{D} farthest from the bottom-layer 14b. The array of wires 44 can be parallel and elongated.

In the target 14 of FIG. 20, the posts 43_{A}, 43_{B}, and 43_{C} have three different thicknesses T_{PA}, T_{PB}, and T_{PC}. The bottom-layer 14b has a thickness T_{B} at a bottom of the holes 33. Thus, the target 14 of FIG. 20 has four different thicknesses T_{PA}, T_{PB}, T_{PC}, and T_{B}. Each thickness can be measured perpendicular to the single plane 191.

The targets 14 of FIGS. 19 and 20, and associated description below, are designed to produce x-rays of different energies. The x-ray tube with these targets 14 can operate at a high voltage (e.g. 55 kV) and produce x-rays primarily in thicker posts 43 (FIG. 19) or 43_{c} (FIG. 20). The x-ray tube with these targets 14 can operate at a low voltage (e.g. 10 kV) and produce x-rays primarily in the bottom-layer 14b between posts 43. The x-ray tube with the target 14 of FIG. 20 can operate at intermediate voltages, such as 25 kV or 40 kV, and produce x-rays primarily in intermediate-sized posts 43_{B} and 43_{C} respectively.

A relationship of a pitch P between adjacent wires (FIG. 19) can be selected relative to a width W_{beam} of the electron beam, for increased production of x-rays. For example, 1.5≤W_{beam}/P, 2≤W_{beam}/P, or 4≤W_{beam}/P; and W_{beam}/P≤6, W_{beam}/P≤12, W_{beam}/P≤20, W_{beam}/P ≤100, or W_{beam}/P≤250. The width W_{beam} includes 90% of the electron beam at the target 14. A higher value for W_{beam}/P has the benefit of less variation in x-ray flux as the electron beam shifts. But, it is more difficult to make a target 14 with higher W_{beam}/P. In FIG. 19, W_{beam}/P=3.8.

An area A_{P} of the bottom-layer 14b covered by the posts 43 can be selected for better x-ray production. Fewer low-energy x-rays are typically produced, because flux is proportional to voltage, and low-energy x-rays are produced at a lower voltage. Therefore, in order to increase production of low-energy x-rays, it is useful for the area A_{B} of the bottom-layer 14b not covered by posts 43 to be greater than the area A_{P} of the bottom-layer 14b with posts 43. For example, 1≤A_{B}/A_{P}, 3≤A_{B}/A_{P}, 6≤A_{B}/Aₚ, or 9≤A_{B}/Aₚ; and A_{B}/Aₚ≤9, A_{B}/A_{P}≤15, or A_{B}/A_{P}≤30. In FIG. 19, A_{B}/A_{P}=1.5. Areas Aₚ and A_{B} are measured parallel to the single plane 191.

The target 14 can include multiple layers of different material, such as for example two or three layers of different material. Each layer can be perpendicular to the single plane 191. The most expensive of these layers can be the bottom-layer 14b, which isn't etched. For example, the bottom-layer 14b can be ≥75 weight percent or ≥95 weight percent rhodium. The posts 43 can be ≥75 weight percent or ≥95 weight percent silver or tungsten. Each layer can be optimized for a different voltage range. Each subsequent layer can be sputter deposited on top of lower layer(s).

A thickness T_{P} of the posts 43 and a thickness T_{B} of the bottom-layer 14b can be selected to improve x-ray generation at both low and high x-ray tube voltages, and to increase x-ray production from sidewalls of the posts 43. For example, 2≤T_{P}/T_{B}, 3≤T_{P}/T_{B}, 6≤T_{P}/T_{B}, or 9≤T_{P}/T_{B}; and T_{P}/T_{B}≤11, T_{P}/T_{B}≤15, T_{P}/T_{B}≤25, or T_{P}/T_{B}≤50. Each thickness T_{P} and T_{B} can be measured perpendicular to the single plane 191.

This thickness ratio T_{P}/T_{B} can be related to the voltage that each thickness T_{P} and T_{B} is designed for. For example, T_{P}/T_{B} can be greater than kV_{B}/kV_{P}, where kV_{P} is a voltage that the thickness T_{P} of the posts 43 are optimized for, and kV_{B} is a voltage that the thickness T_{B} of the bottom-layer 14b is optimized for.

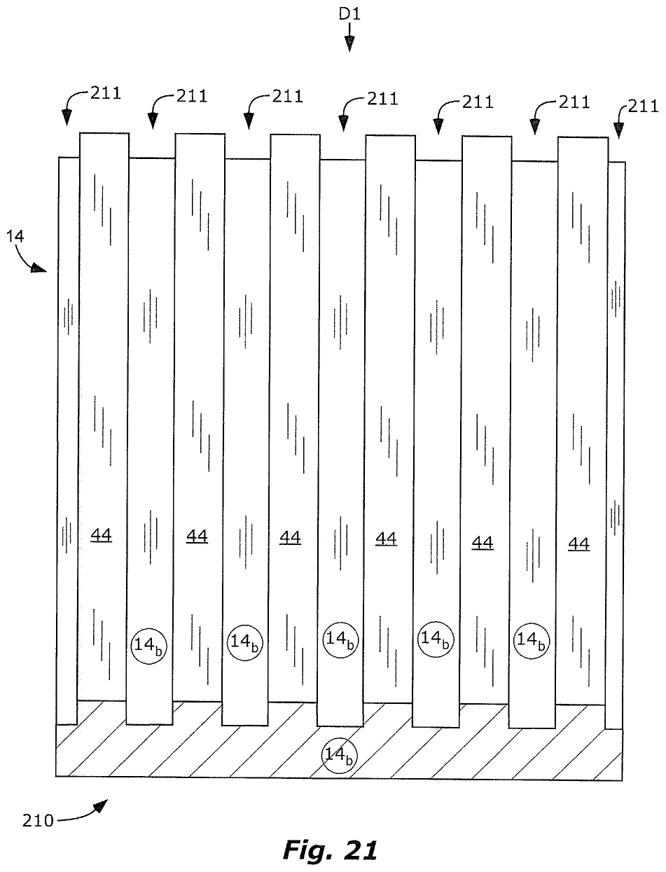

A method of making a target 14 for an x-ray tube can include step 210 (FIG. 21), patterning and etching a first array of channels 211 in a target material in a first direction D1, forming an array of wires 44 extending from a bottom-layer 14b. Adjacent wires 44 can be separated from each other by a channel 211.

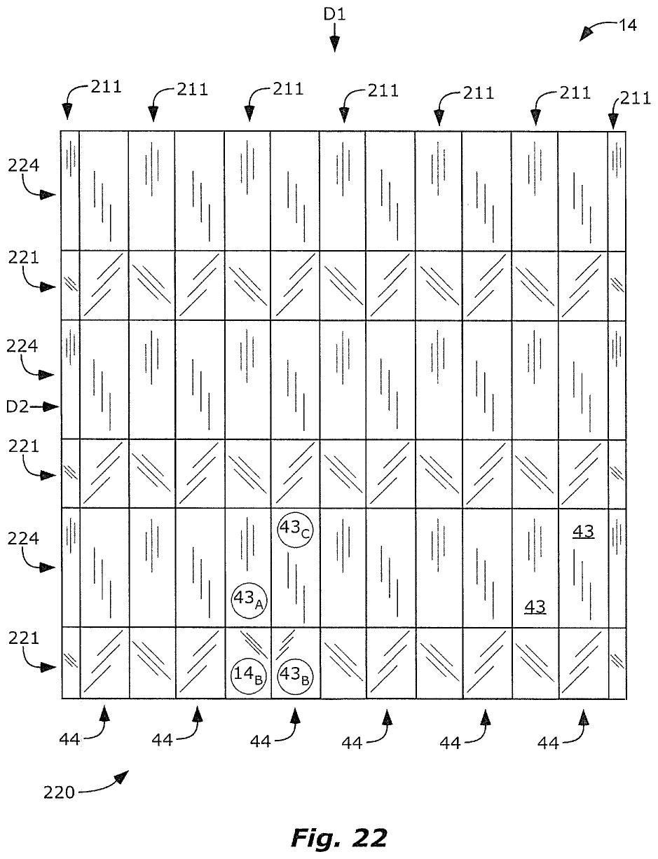

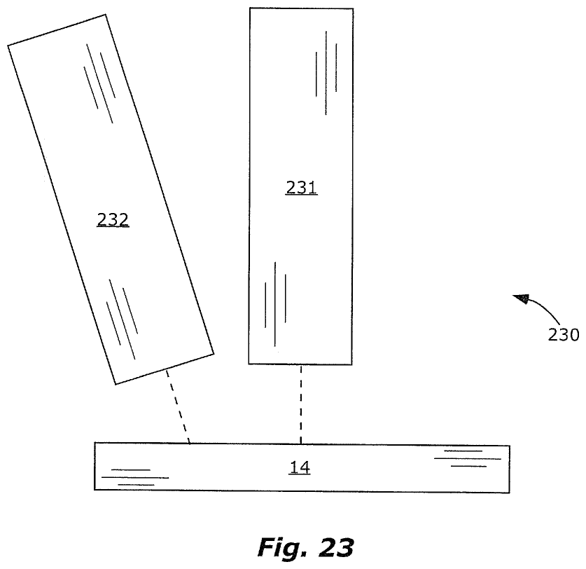

The method can further comprise step 220 (FIG. 22), patterning and etching a second array of channels 221, or patterning and sputtering an array of wires 224 of target material, in a second direction D2. The second direction D2 can be different from the first direction D1. The second direction D2 can be perpendicular to the first direction D1. This step 220 can form an array of posts 43 extending from the bottom-layer 14b. There can be additional patterning and etching step(s) in different directions, to form additional posts 43 of additional thicknesses.

The etching of steps 210 and 220 can be different depths with respect to each other, resulting in posts 43_{A}, 43_{B}, and 43_{C} that have three different thicknesses T_{PA}, T_{PB}, and T_{PC}, as illustrated in FIG. 20. Alternatively, the etching of steps 210 and 220 can be the same depth with respect to each other, resulting in posts 43_{A}, 43_{B}, and 43_{C} that have two different thicknesses T_{PA}=T_{PB}, and T_{PC}.

Another method of making a target 14 for an x-ray tube with step 210 (FIG. 21) can include patterning and sputtering an array of wires 44 on a bottom-layer 14b. Adjacent wires 44 can be separated from each other by a channel 211.

The wires 44 and the bottom-layer 14b can be a target material. Target material of the bottom-layer 14b can be different from, or the same as, target material of the wires 44.

A first array of wires 44 of target material can be patterned and sputtered on the bottom-layer 14b in a first direction D1, then a second array of wires 244 can be patterned and sputtered in a second direction D2. The second direction D2 can be different from the first direction D1.

The patterning and sputtering of steps 210 and 220 can be different thicknesses with respect to each other, resulting in posts 43_{A}, 43_{B}, and 43_{C} that have three different thicknesses T_{PA}, T_{PB}, and T_{PC}, as illustrated in FIG. 20. Alternatively, the patterning and sputtering of steps 210 and 220 can be the same thickness with respect to each other, resulting in posts 43_{A}, 43_{B}, and 43_{C} that have two different thicknesses T_{PA}=T_{PB} and T_{PC}.

A method of making a target 14 for an x-ray tube 10a, 10b, or 20 can comprise using a laser 231 or 232 to form holes 33 in the target 14, posts 43 on the target, or both. The laser 231 or 232 can be a high power laser, so that material of the holes 33 is removed by ablation. Ablation is preferred over melting because melting can change or damage the grain structure of remaining target material. This change or damage can be avoided by a high power laser 231 or 232 that uses picosecond pulses, femtosecond pulses, or both to form the holes 33 or posts 43 by ablation. A large portion of material of the holes 33 can be removed by ablation, such as for example ≥25%, ≥50%, ≥75%, or ≥90%. The laser 232 can be tilted at an oblique angle, with respect to the target 14, to form the holes 33 of FIG. 5 or the posts 43 of FIG. 6.

Another method of making the target 14 for the x-ray tube 10a, 10b, or 20 can comprise isotropic etching, anisotropic etching, or alternating isotropic and anisotropic etching. Other methods include deep reactive-ion etching and focused ion beam milling.

What is claimed is:

1. An x-ray tube comprising:
a cathode and an anode electrically insulated from one another, the cathode configured to emit electrons in an electron beam to a target at the anode, the target configured to emit x-rays in response to impinging electrons from the cathode;
an array of holes in the target; and
adjacent rows of the array of holes are offset with respect to each other such that a line across each row crosses holes of every other column.

2. The x-ray tube of claim 1, wherein the array of holes form repeating hexagonal shapes.

3. The x-ray tube of claim 1, wherein each hole has a circular shape or an elliptical shape at a face of the target.

4. The x-ray tube of claim 1, wherein a longitudinal-axis for each of the holes is parallel to a longitudinal axis of the x-ray tube between the cathode and the target.

5. The x-ray tube of claim 1, wherein Dₕ₃/Dₕ₁≥1.25 or Dₕ₁/Dₕ₃≥1.25, where Dₕ₁ is a minimum diameter of the hole measured at a face of the target and Dₕ₃ is a minimum diameter of the hole measured at a bottom of the hole.

6. An x-ray tube comprising:
a cathode and an anode electrically insulated from one another, the cathode configured to emit electrons in an electron beam to a target at the anode, the target configured to emit x-rays in response to impinging electrons from the cathode;
an array of holes in the target; and
an average direction of sidewalls of the holes is unparallel with respect to a longitudinal axis of the x-ray tube between the cathode and the target.

7. The x-ray tube of claim 6, wherein Dₕ₂/Dₕ₁≤5, where Dₕ₁ is a minimum diameter of the hole and Dₕ₂ is a maximum diameter of the hole, both measured at a face of the target.

8. The x-ray tube of claim 6, wherein the holes increase in diameter moving deeper into the holes.

9. The x-ray tube of claim 6, wherein the holes decrease in diameter moving deeper into the holes and each hole has a conical shape.

10. The x-ray tube of claim 6, wherein the average direction of the sidewalls of the holes is unparallel with respect to the longitudinal axis due to bumps across at least 80% of a surface of the sidewalls.

11. An x-ray tube comprising:
a cathode and an anode electrically insulated from one another, the cathode configured to emit electrons in an electron beam to a target at the anode, the target configured to emit x-rays in response to impinging electrons from the cathode;
an array of holes in the target; and
a longitudinal-axis for each of the holes is parallel to a longitudinal axis of the x-ray tube between the cathode and the target.

12. The x-ray tube of claim 11, wherein at least 25% of the electron beam enters the holes.

13. The x-ray tube of claim 11, wherein:
the x-ray tube is a transmission-target x-ray tube and the target adjoins an x-ray window; and
the longitudinal-axis of the x-ray tube is perpendicular to a plane of a face of the target.

14. The x-ray tube of claim 11, wherein:
the x-ray tube is a reflective-target x-ray tube and the target is spaced apart from an x-ray window; and
100°≤Aₕ≤140°, where Aₕ is an angle between the longitudinal-axis of the x-ray tube and a plane of a face of the target.

15. The x-ray tube of claim 11, wherein:
1 μm≤Dₕ₁, ≤20 μm, 1≤ARₕ≤10, and ARₕ=dₕ/Dₕ₁;
where for each hole, Dₕ₁ is a minimum diameter of the hole measured at a face of the target, ARₕ is an aspect ratio of the hole, and dₕ is a depth of the hole measured at a center of the hole.

16. The x-ray tube of claim 11, wherein 300 nm≤Sₕ≤20 μm, where Sₕ is a minimum distance between adjacent holes, measured at a face of the target.

17. The x-ray tube of claim 11, wherein:
the target includes a top-layer closest to the cathode and a bottom-layer farther from the cathode;
the array of holes is in the top-layer;
each hole extends through the top-layer to expose the bottom-layer; and
the top-layer has a different material composition from the bottom-layer.

18. A method of making the target of claim 11, the method comprising using a laser to form the holes in the target by ablation.

19. A method of making the target of claim 11, the method comprising isotropic etching to form the holes in the target.

20. The method of claim 19, the method further comprising anisotropic etching to form the holes in the target.
